(19) United States
(12) Patent Application Publication
(10) Pub. No.: US 2018/0363829 A1
(43) Pub. Date: Dec. 20, 2018

(54) Method of providing a drag force on a pipeline pig

(71) Applicant: Benton Frederick Baugh, Houston, TX (US)

(72) Inventor: Benton Frederick Baugh, Houston, TX (US)

(21) Appl. No.: 15/625,215

(22) Filed: Jun. 16, 2017

(51) Int. Cl. F16L 55/40; F16L 55/38; B08B 9/055; F16D 63/00

(52) U.S. Cl. CPC F16L 55/40; F16L 55/38; F16L 2101/30; F16D 63/00; B08B 9/0558

(57) ABSTRACT

The method of attaching or integrating a drag force on a service pig within a pipeline to improve the service operations such as jet cleaning or quality control inspections, comprising providing one or more drag members such as blocks or wheels and engaging the drag members with the inner wall of said pipeline.

### TECHNICAL FIELD

This invention relates to the method of providing a drag force on a pig within a subsea pipeline to assist the pig to performing cleaning and/or inspection functions.

### BACKGROUND OF THE INVENTION

Pigs within subsea pipelines tend to move along the pipeline at the same speed as the flow within the pipeline moves, unless there is gas in the flow at which time they can have more of a start and stop motion. In the case of some passive cleaning pigs which are intended to simply wipe forming paraffin or wax of the wall of the pipeline, this is satisfactory. As these passive pigs typically don't remove the paraffin or wax off the bore of the pipeline but rather compresses it onto the wall, other types of cleaning pigs are required to fix the problems they cause.

One pig which needs to be assisted is one on which needs to have a pressure differential across the pig to establish jetting pressure for jet cleaning. This force can be supplied in a relatively short pipeline by a restraining cable, hose, or pipe, but it is simply not practical in pipeline longer than a couple of miles long.

Another pig which typically has a problem with this is an inspection pig which needs to move at a constant velocity so the inspection data can be reasonably interpreted. As there is frequently some or a lot of gas in the pipeline, there is a tendency for the pig to be stationary until the static wall friction is overcome by a pressure differential force. When the static friction is overcome, the inspection pig will accelerate quickly as the dynamic friction is lower than the static friction. The acceleration and inertia gained by the inspection pig will cause it to out run the driving gas force and it will tend to stop again and return to static friction. The pressure builds up again and the process is repeated. The resulting electronic inspection data is erratic and difficult to interpret. If you have located a potential problem within the pipeline, actual location of the pipeline problem is masked by the erratic movement of the inspection pig.

These problems are well documented in the problems associated with the thousands of miles which have been inspected. In spite of this, no satisfactory solutions to either of these problems have not been found before this invention.

### BRIEF SUMMARY OF THE INVENTION

The object of this invention is to provide a method of restraining a pig within a pipeline without providing a cable, hose, or tube.

A second object of this invention is to provide a method of restraining a pig within a pipeline without providing a cable, hose, or tube which can be connected to a cleaning or inspection pig.

A third objective of this invention is to provide a method of restraining a pig within a pipeline which has an adjustable restraining force.

Another objective of this invention is to provide a restraining force by engaging the inner wall of the pipeline.

Another objective of this invention is to allow restraint in one direction and not in the other direction.

### BRIEF DESCRIPTION OF THE DRAWINGS

FIG. 1 is a section of a subsea pipeline showing the present invention in the general environment in which it will work.

FIG. 2 is a graphic illustrating speed vs. distance travelled for a pig in a pipeline experiencing friction and a compressible fluid.

FIG. 3 is a graphic illustrating the driving pressure vs. distance travelled for a pig in a pipeline experiencing friction and a compressible fluid.

FIG. 4 is a graphic illustrating the driving vs. distance travelled for a pig in a pipeline restrained by the benefit of this invention.

FIG. 5 is an external view of a drag pig of this invention.

FIG. 6 is an external view of a service pig which might be benefited by this invention.

FIG. 7 is a cross section of FIG. 5 taken along lines “7-7” showing the drag wheel being spring loaded against the bore of the pipeline.

FIG. 8 is a cross section of FIG. 7 taken along lines “8-8” showing the internal parts of the drag pump.

FIG. 9 is a cross section of FIG. 8 taken along lines “9-9” showing the hydraulic flow path through the drag pump.

FIG. 10 is a hydraulic schematic of an embodiment of this invention.

### DETAILED DESCRIPTION OF THE INVENTION

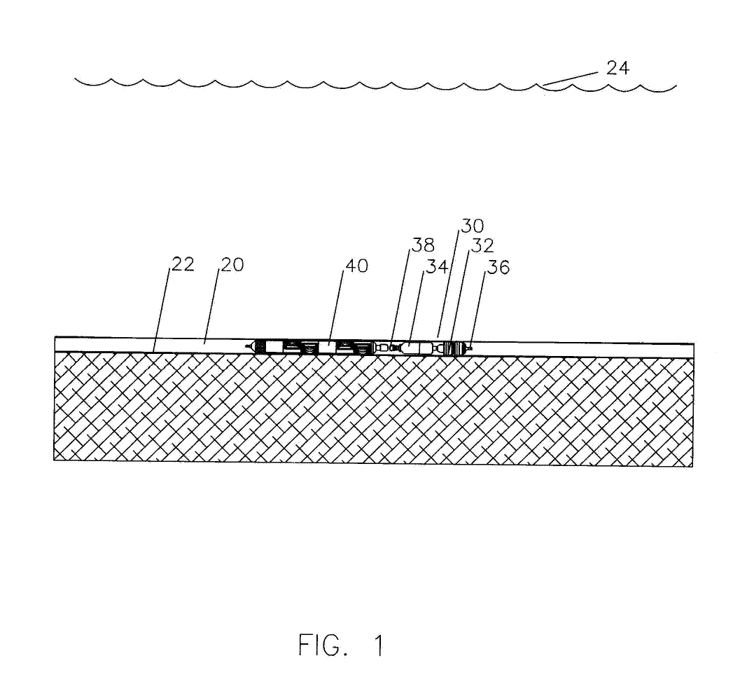

Referring now to FIG. 1, pipeline 20 is laying of the seafloor 22 in the ocean 24. Pipeline is shown simply going off the edges of the drawing as it represents a pipeline which may well be miles long. Service pig 30 is shown in the pipeline 20 having sealing cups 32 which in this case is pulling a package 34 with it. Fishing neck 36 is provided on the front of the service pig 30 and fishing neck 38 is on the rear of service pig 30, but is not visible in this view. Package 34 can be an inspection tool which is doing required inspections of the pipeline. If the pig is for cleaning, jet nozzles will be located in the front in the area of fishing neck 36. Drag pig 40 is the tool embodying the features of this invention.

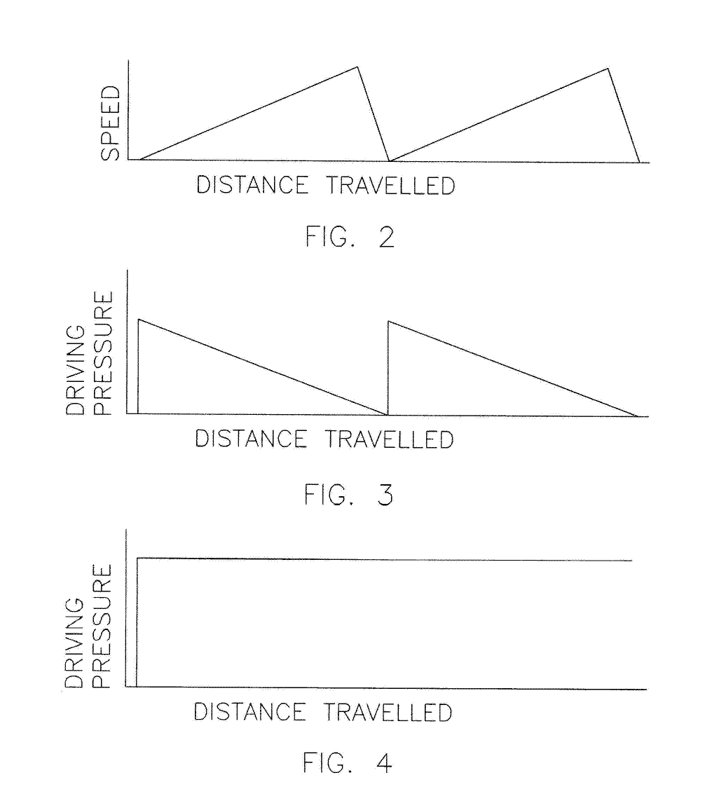

Referring now to FIG. 2, whether cleaning or inspecting, service pigs of this sort are sensitive to the unpredictable movement in the pipeline when volumes of gas are present. This is especially true when the pipeline is a gas only pipeline. Consider at the left of the figure that the pig is stopped and the pressure has just built up to the point that it will overcome static friction of the sealing cups and any other drag on the pig. It has zero velocity and starts to accelerate. As it travels the distance to the middle of this figure it has pressure force to accelerated the service pig at least a portion of the way. When the gas expands behind the pig, at some point the pressure will become insufficient to provide force to overcome the dynamic friction and the pig will begin to slow down. In this ideal case, the pig will stop, whereas the difference may well not be this dramatic. The right side of this FIG. 2 indicates the cycle is repeated a second time. As you might expect, this can wreak havoc on a service operation.

Referring now to FIG. 3, travelling over the same distance, one can see that as the pig is accelerating in FIG. 2, the driving pressure is declining.

Referring now to FIG. 4, the method of this invention is illustrated that by imposing an artificial pressure differential on the pig, the pressure differences can be masked or dampened such that the pig can be caused to move as a constant speed.

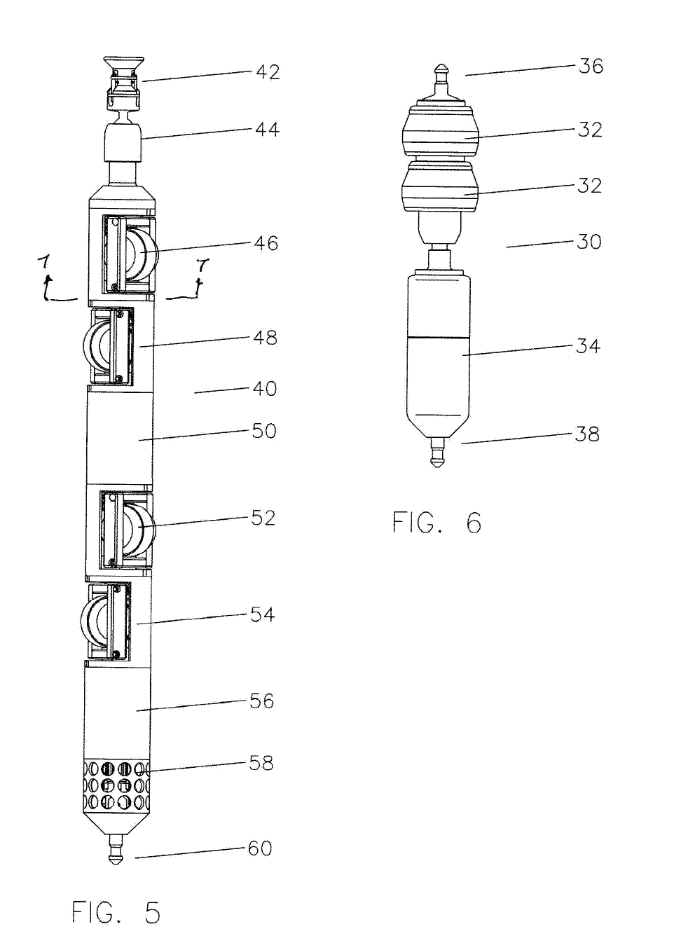

Referring now to FIG. 5 drag pig 40 is shown having a latch 42 on the front, a flex joint 44, drag wheels 46-56, hydraulic section 58 and fishing neck 60. The six drag wheels 46-56 are in two groups of three wheels each place at 120 degrees to provide stability to the tool in the bore.

Referring now to FIG. 6, the service pig 30 is shown with the fishing necks 36 and 38 shown.

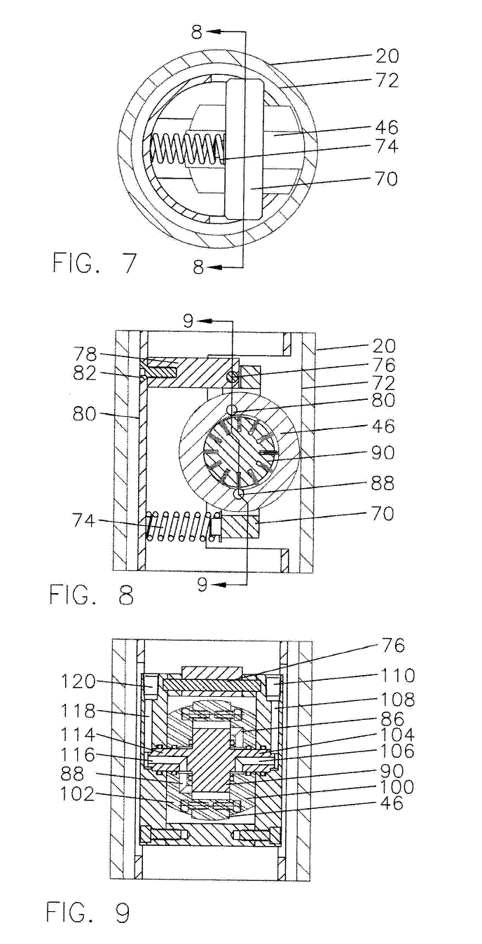

Referring now to FIG. 7, a section of drag pig 40 taken along lines “7-7” of FIG. 5 illustrating drag wheel 46 mounted in frame 70 and loaded against inner wall 72 of pipeline 20 by spring 74.

Referring now to FIG. 8, a section of drag pig 40 taken along lines “8-8” of FIG. 7 showing frame 70 pivoting about axle 76 on post 78 which is in turn mounted on drag pig body 80 by screws 82. Drag wheel 46 is shown be have an internal pump 84 of a vane type with fluid ports 86 and 88. Usually the central rotor 90 on a vane motor rotates, but in this case the central rotor 90 is non-rotational and the drag wheel 46 rotates.

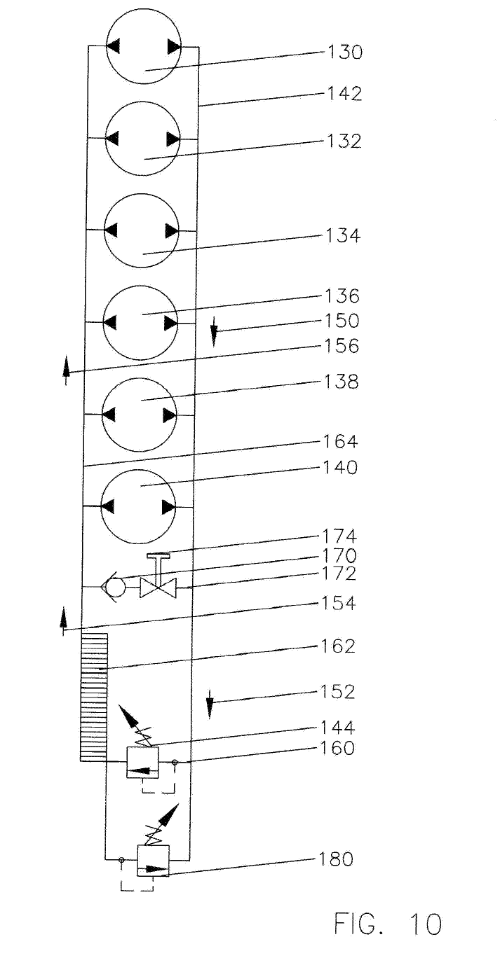

Referring now to FIG. 9, a section of drag pig 40 taken along lines “9-9” of FIG. 8 showing drag wheel 46 having attached side plates 100 and 102 which rotate with it. Central rotor 90 has shaft 104 on a first side with internal port 106 leading to porting 108 and connection 110. Central rotor 90 also has shaft 114 on the second side with internal port 116 leading to porting 118 and connection 120. Ports 104 and 114 communicate with porting 86 and 88 respectively such that rotation of drag wheel 46 in a first direction will pump fluid from port 110 to port 120 and rotation of drag wheel 46 in the opposite direction will pump fluid from port 120 to port 110.

Referring now to FIG. 10, a hydraulic schematic for draw pig 40 is shown with bi-directional pumps 130-140 which would correspond to drag wheels 46-56. Fluid lines 142 collects the fluids from one side of said bi-directional pumps 130-140 and directs it to adjustable relief valve 144, which limits the pressure in line 142 and therefore the torque on bi-directional pumps 130-140 and therefore to drag wheels 46-56. The primary fluid flow direction is indicated by arrows 150-156. Fluid exits adjustable relief valve 144 via line 160 through cooler 162 and line 164 and back to bi-directional pumps 130-140.

When drag pig 40 moves the opposite direction down a pipeline, the flow will be in the opposite direction. As no drag is likely to be desired in the opposite direction, check valve 170 is provided in line 172 to allow free flow in this direction through valve 174, as long as it is open.

When flow and drag are desired in the opposite direction, valve 174 can be closed, and flow will be directed through adjustable relief valve 158. In this way drag can be imposed on the movement in both directions, according to the settings on the relief valves 144 and 180.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

### SEQUENCE LISTING: N/A

That which is claimed is:

1. The method of providing a drag force on a service pig within a pipeline to improve the service operations, comprising
providing one or more drag members, and
engaging said drag members with the inner wall of said pipeline.

2. The method of claim 1, further comprising said drag members are drag blocks.

3. The method of claim 2, further comprising said drag blocks are engaged against said inner wall of said pipeline by hydraulic pressure.

4. The method of claim 2, further comprising said drag blocks are engaged against said inner wall of said pipeline by one or more springs.

5. The method of claim 1, further comprising said drag members are drag wheels.

6. The method of claim 5, further comprising said drag wheels are engaged against said inner wall of said pipeline by one or more springs.

7. The method of claim 5, further comprising said drag wheels are engaged against said inner wall of said pipeline by fluid pressure.

8. The method of claim 5, further comprising said drag wheels are restrained against rotary motion by a pressure differential.

9. The method of claim 8, further comprising said pressure differential is provided by fluid flow from a pump flowing across a fluid restriction.

10. The method of claim 8, further comprising said a pump is a vane style pump.

11. The method of claim 8, further comprising said fluid restriction is an adjustable relief valve.

12. The method of providing a drag force on a service pig within a pipeline to improve the service operations, comprising
providing one or more drag wheels,
providing a drag mechanism for said one or more drag wheels, and
engaging said one or more drag wheels with the inner wall of said pipeline.

13. The method of claim 12, further comprising said drag wheels are engaged against said inner wall of said pipeline by one or more springs.

14. The method of claim 12, further comprising said drag wheels are engaged against said inner wall of said pipeline by fluid pressure.

15. The method of claim 12, further comprising said drag wheels are restrained against rotary motion by a pressure differential.

16. The method of claim 15, further comprising said pressure differential is provided by fluid flow from a pump flowing across a fluid restriction.

17. The method of claim 15, further comprising said a pump is a vane style pump.

18. The method of claim 15, further comprising said fluid restriction is an adjustable relief valve.

19. The method of claim 12, further comprising said drag is provided as an integral part of said service pig.

20. The method of claim 12, further comprising said drag is provided as an as an attachment to said service pig.
